(19) United States
(12) Patent Application Publication
(10) Pub. No.: US 2023/0043619 A1
(43) Pub. Date: Feb. 9, 2023

(54) DESCRIBING TRANSACTIONS USING UNICODE EMOJIS

(71) Applicant: Capital One Services, LLC, Mclean, VA (US)

(72) Inventors: Pavel Fort, Westbury, NY (US); Timur Sherif, Silver Spring, MD (US); Jeffrey Wieker, Falls Church, VA (US)

(21) Appl. No.: 17/396,369

(22) Filed: Aug. 6, 2021

(51) Int. Cl. G06Q 20/08; G06Q 20/20; G06N 20/00; G06F 3/0482

(52) U.S. Cl. CPC G06Q 20/085; G06Q 20/20; G06N 20/00; G06F 3/0482

(57) ABSTRACT

Systems as described herein may describe transactions using Unicode emojis. A description server may obtain transaction data associated with an entity. At least one feature of the transaction may be determined using a machine classifier. The description server may determine a visual representation for each feature associated with the transaction. Accordingly, a transaction summary comprising the transaction data and the visual representations may be generated and provided to a computing device.

### FIELD OF USE

Aspects of the disclosure relate generally to data processing and more specifically to the processing and management of big data.

### BACKGROUND

In an electronic payment processing network, a financial institution may receive transaction data originated from a variety of merchants. Due to the limited nature of the transaction data, financial institutions may not have the ability to offer more descriptive information on the transactions to their customers. As a result, conventional financial systems may fail to provide transaction descriptions and visual representations to facilitate their customers to understand their personal finances.

Aspects described herein may address these and other problems, and generally improve the quality, efficiency, and speed of processing data to offer insights into transaction data so that users may make informed decisions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for describing transactions using Unicode emojis. A description system may obtain transaction data associated with an entity (e.g. a merchant). The transaction data may indicate an entity code (e.g. a merchant category code), an entity name and a transaction value. Using a machine classifier, the description system may determine at least one feature of the transaction based on the entity code, the entity name and the transaction value. Each feature may include a confidence metric indicating a likelihood that the feature may be associated with the transaction. The description system may determine a visual representation, such as an emoji selected from Unicode Technical Standard #51 for each feature. The description system may subsequently generate a transaction summary including the transaction data and the visual representations of the features of the transaction. The transaction summary may be provided to a computing device (e.g. a user device) for further processing and/or review.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system for describing transactions using Unicode emojis in which one or more aspects described herein may be implemented;

FIG. 2 shows an example computing device in accordance with one or more aspects described herein;

FIG. 3 shows a flow chart of a process for describing transactions using Unicode emojis according to one or more aspects of the disclosure;

FIG. 4 shows a flow chart of a process for determining Unicode emojis using a machine classifier according to one or more aspects of the disclosure; and

FIGS. 5A-5B show example user interfaces displaying Unicode emojis according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for describing transactions using Unicode emojis. In an electronic payment processing network, a financial institution may receive transaction data originated from a variety of merchants. The transaction data may include an entity code, such as a merchant category code (MCC), an entity name and a transaction value. To facilitate their customers to understand the nature of the transactions, the financial institutions may generate a transaction summary based on the aggregated transaction data. However, due to the limited information in the transaction data, conventional financial systems may not be able to translate the transaction data into more meaningful descriptions, and thereby limiting their ability to provide their customers with insights to the transactions and develop effective alert or reward systems.

The transaction data may be obtained from a point of sale device associated with the entity. The transaction data may further include location data for the transaction and at least one feature of the transaction may be determined based on the location data. The transaction data may further include context data for the transaction and at least one feature of the transaction may be determined based on the context data. The description system may obtain an annotation indicating a visual representation and a label indicating the correctness of the indicated visual representation. The machine classifier may be retrained based on the annotation, the label, and the transaction data.

In many aspects, the description system may determine that the value of the transaction exceeds a threshold value and may associate multiple visual representations with the transaction data. The multiple visual representations may be associated with the value of the transaction.

The description system as described herein allows for determining a transaction category for the transaction based on at least one feature determined by the description system. The description system may classify the transaction data in the transaction summary based on the transaction history.

### Description Systems

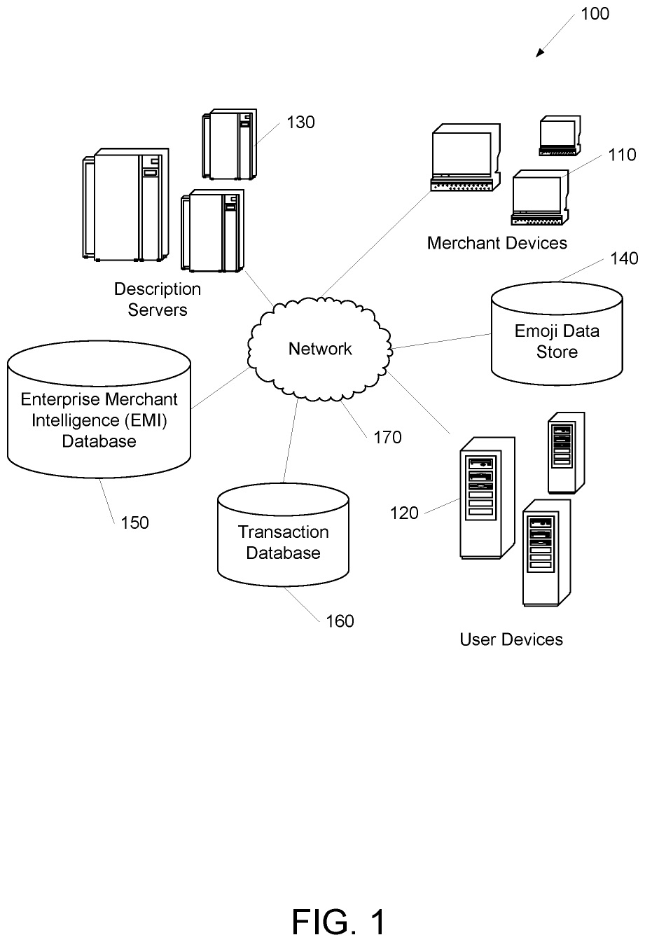

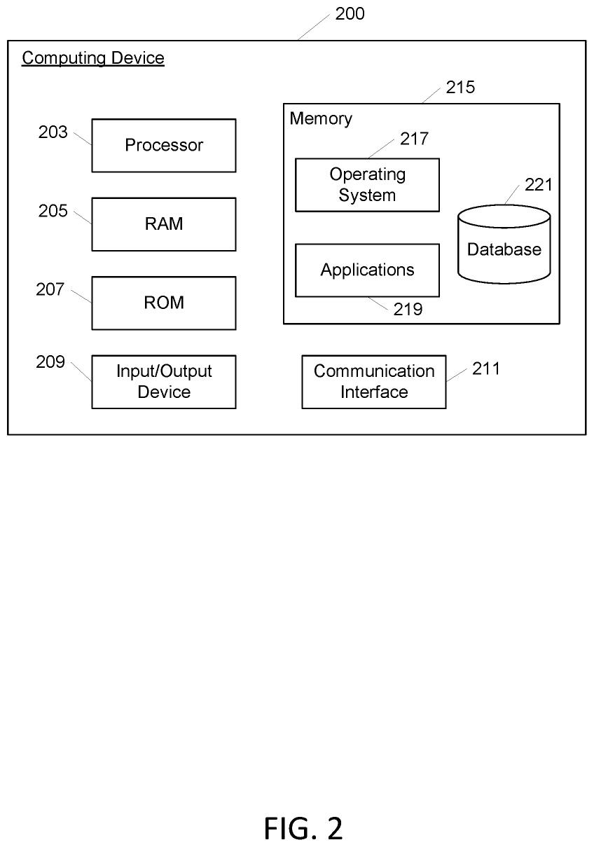

FIG. 1 shows an example of a system 100 where transactions may be described using Unicode emojis. The system 100 may include one or more merchant devices 110, one or more user devices 120, at least one description server 130, at least one emoji data store 140, at least one enterprise merchant intelligence (EMI) database 150, and/or at least one transaction database 160 in communication via a network 170. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices described with respect to FIG. 2.

Merchant devices 110 may submit transaction information related to a transaction such as a transaction identifier, an entity identifier or name (e.g. merchant identifier or merchant name), an entity code (e.g. MCC), a transaction value, a transaction location, and/or a transaction timestamp. In some examples, merchant devices 120 may also send context information related to the transaction, such as whether the transaction occurred online or in a physical store, or whether it was a card-present transaction. The entity code, such as an MCC may be a four-digit number used by credit card companies to classify businesses into market segments. The MCC may indicate the types of services or goods being sold to customers. The financial intuitions may use the MCCs to classify transactions. Some merchant devices 110 may be a Point of Sale (POS) device located at a merchant. The merchant may be a small business merchant, such as a convenience store, a coffee shop, a gas station, a farmer's market, etc. These merchants may assign the entity codes such as MCCs to represent the types of the services or goods provided by the merchants on a per POS basis.

User devices 120 may be any device that belongs to a customer of a financial institution. The customers may conduct transactions with merchant devices 110 using user devices 120. For example, a customer may bring user devices 120 to the vicinity of a POS device and submit payment information to the POS device. The customer may make an online payment using user devices 120 that submit the payment information to merchant devices 110. User devices 120 may receive a transaction summary indicating categories of previously conducted purchases. The transaction summary may include visual representations of the features of the transaction. The visual representations may be, for example, emojis selected according to Unicode Technical Standard #51.Other visual presentations of the features of the transaction may also be possible. User devices 120 may receive recommendations on purchases related to the transaction data or information on reward program that the customers may be eligible to participate. User devices 120 may provide feedback (e.g. a label indicating the correctness of the visual representations) on the visual representations, their annotations, and the corresponding transaction data. User devices 120 may provide additional visual representations that may better describe the transaction. User devices 120 may include computing devices, such as laptop computers, desktop computers, mobile devices, smart phones, tablets, and the like. According to some examples, user devices 120 may include hardware and software that allow them to connect directly to network 170. Alternatively, user devices 120 may connect to a local device, such as a personal computer, server, or other computing device, which connects to network 170.

Description server 130 may receive transaction information containing raw transaction data from merchant devices 110 originated from a plurality of merchants. Description server 130 may attempt to clean the raw transaction data. The raw transaction data may be in the form of a line of data that offers limited information about the transaction, with each piece of information appearing in certain locations within the line of data. For example, an entity identifier may appear in a specific location and may include 8-10 characters in the abbreviated form. Some entity identifier may not be readily recognizable as a meaningful merchant name, particularly for small business merchants. Description server 130 may process this abbreviated merchant identifier and convert it into a meaningful merchant name in a human readable format.

Description server 130 may use a machine classifier to determine one or more features of the transaction based on the entity code, the entity name and a transaction value. The features may include meaningful descriptions of the transaction, such as merchant description, purchase description, location data (e.g. city or zip code), transaction context data (e.g. online purchase or purchase made in a physical store, whether a card-present purchase, and/or a time of the day). The features may also be associated with a transaction value, such as whether the purchase is a low value or high value purchase. The machine classifier may determine a confidence metric indicating a likelihood that the feature is associated with the transaction. For example, the machine classifier may be trained using a set of transaction data and a set of known features associated with the transactions. The confidence metric may include a confidence score generated based on a similarity of a feature of the transaction to a feature of the at least one transaction in the set of training transaction data based on the entity code, the entity name and/or a transaction value. The machine classifier may determine the feature of the transaction, based on the confidence score exceeding a threshold value (e.g. 90%). In an example, the machine classifier may determine that the entity code associated with the transaction may be an MCC related to catering service with a confidence score of 99%. The machine classifier may determine that the entity name associated with the transaction may be Ruth's Chris steak house with a confidence score of 95%. The machine classifier may determine that the transaction value 200 may be considered as a high value purchase (with a confidence score of 97%) and may be related to a purchase of a meal with steak and drinks (with a confidence score of 93%). The machine classifier may determine these relevant features of the transaction given that the respective confidence score has exceeded the 90% threshold value.

Description server 130 may determine a visual representation for each feature associated with the transaction. In a variety of embodiments, description server 130 may map each feature of the transaction to an emoji according to Unicode Technical Standard #51.Description server 130 may search a Unicode emoji data store based on the feature and retrieve a list of the emojis that may be relevant to the transaction. For example, description server 130 may determine a steak emoji, a drink (wine or cocktail) related to the purchase descriptions. Description server 130 may determine, for example, a smiling face with S eyes emoji to represent the high value purchase.

Description server 130 may obtain an annotation indicating a visual representation and a label indicating the correctness of the indicated visual representation for the transaction from user devices 120. For example, the transaction of S200 may be annotated with steak and wine, and a money-mouth emojis, which may be send to user devices 120. A user may provide feedback (e.g. a label) via user devices 120, that the emojis and annotations have correctly identified the previous transaction at Ruth's Chris Steak House. Description server may obtain feedback and labels from a variety of user devices and retrain the machine classifier based on the annotations, the labels, and the transaction data.

Description server 130 may generate a transaction summary including the transaction data and visual representations. For example, the transaction summary may display categories of previously conducted purchases made by a customer. Description server 130 may determine a transaction category for the transaction based on the entity code. Description server 130 may classify the transaction data in the transaction summary based on the transaction category. The transaction summary may include transaction data and visual representations of the features of the transactions. The transaction summary may include alerts and recommendations related to the expenditures in the transaction summary and/or reward programs that the customer may be eligible to participate.

Emoji data store 140 may store a plurality of emojis, which may be ideograms and smileys used in electronic messages and web pages. Emoji may exist in various genres, such as facial expressions, common objects, places and types of weather, and animals. In a variety of embodiment, Unicode 13.0 represents emojis using 1,367 characters spread across 24 blocks, where 26 characters are Regional Indicator Symbols that combine in pairs to form flag emojis and 12 characters (#, * and 0-9) are base characters for keycap emoji sequences. For example, 637 of the 768 code points in the Miscellaneous Symbols and Pictographs block are considered emoji. 240 of the 254 code points in the Supplemental Symbols and Pictographs block are considered emoji. All of the 57 code points in the Symbols and Pictographs Extended-A block are considered emoji. All of the 80 code points in the Emoticons block are considered emoji. 101 of the 114 code points in the Transport and Map Symbols block are considered emoji. 83 of the 256 code points in the Miscellaneous Symbols block are considered emoji. 33 of the 192 code points in the Dingbats block are considered emoji. Unicode emojis may have standard names, and description server 130 may retrieve an emoji from emoji data store 140 based on the feature of the transaction matching a name of the emoji.

Emoji data store 140 may include a third-party service that may provide the emoji representations based on names or annotations. Description server 130 may determine the visual representations by querying the third-party service to obtain an emoji corresponding to the name or annotation related to a feature of the transaction.

Enterprise merchant intelligence (EMI) database 150 may store merchant records related to various merchants, including small business merchants. EMI database 150 may be a merchant database that stores enterprise merchant intelligence records, which may in turn include a merchant identifier, a friendly merchant name, a zip code, a physical address, a phone number, an email, or other contact information of the merchants, and/or a corresponding MCC. Description server 130 may process the raw transaction data, extract the merchant information from the transaction data and store the corresponding merchant information corresponding to the transaction data in EMI database 150.

In a variety of embodiments, description server 130 may build a proprietary EMI database 150, for example, based on an aggregation of transaction records received in the transaction stream. As a transaction arrives from a transaction stream, the corresponding transaction record may be processed, cleaned, and/or enhanced with a variety of services. In a variety of embodiments, description server 130 may use a third-party API to gather merchant information, such as an MCC, a merchant address or contact information, to be stored in EMI database 150. In a variety of embodiments, description server 130 may maintain static merchant information, such as a merchant identifier and merchant name, in its proprietary EMI database 150 and description server 130 may use the third-party API to get merchant address, merchant location data, merchant social media handle, MCCs, or other merchant information that may change over time.

Transaction database 160 may store transaction records related to transactions previously conducted by customers in transaction streams from a plurality of merchants. Transaction database 160 may receive a request from description server 130 and retrieve the corresponding transaction data in the transaction streams. The transaction data may each contain an account identifier, a transaction value, a transaction time, a merchant identifier, MCC, etc. After the transaction data is processed by description server 130, the corresponding transaction data and the visual representations of the features or labels may be stored in transaction database 160. In some examples, the transaction data may be used to train or retrain the machine classifier may also be stored in transaction database 160.

Merchant devices 110, user devices 120, description server 130, emoji data store 140, EMI database 150, and/or transaction database 160 may be associated with a particular authentication session. Description server 130 may receive, process, and/or store a variety of transaction records, merchant intelligence information and location information, and/or receive transaction records with merchant devices 110 as described herein. However, it should be noted that any device in system 100 may perform any of the processes and/or store any data as described herein. Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. Network 170 may include a local area network (LAN), a wide area network (WAN), a wireless telecommunications network, and/or any other communication network or combination thereof.

The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the data sharing system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

### Computing Devices

Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. Memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

### Describing Transactions Using Unicode Emojis

The description system may process raw transaction data, translate certain data such as entity names, location data and context data into terms that may be used to search the Unicode emoji database and return a list of emojis that may be relevant to the transaction. The description system may implement a layer of feedback loop when the emojis are displayed to customers for their feedback on whether the emojis correctly describe the transactions. The system may optimize what emojis may be shown for the corresponding transactions. As such, the transaction data may be transformed into visual representations that may resonance with the customers to facilitate communication and decision making.

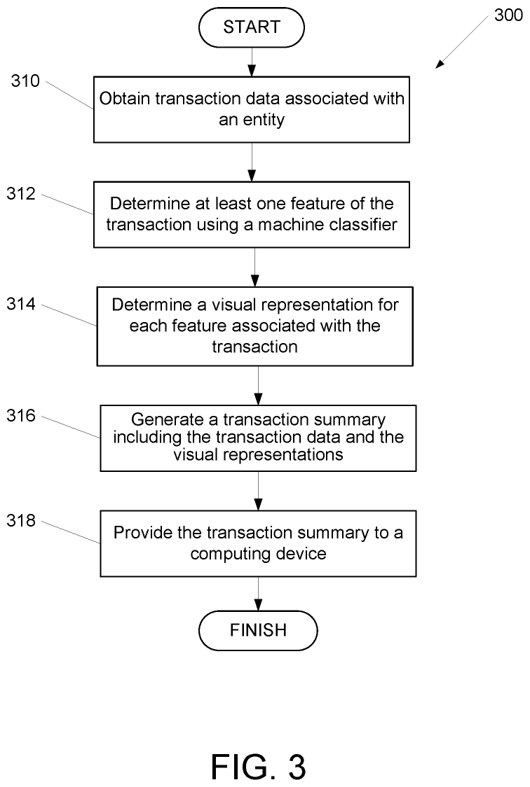

FIG. 3 shows a flow chart of a process for describing transactions using Unicode emojis according to one or more aspects of the disclosure. Some or all of the steps of process 300 may be performed using one or more computing devices as described herein. In a variety of embodiments, some or all of the steps described below may be combined and/or divided into sub-steps as appropriate.

At step 310, a description server may obtain transaction data associated with an entity, such as a merchant. The transaction data may include an entity code (e.g. MCC), an entity name (e.g. merchant name) and a transaction value. The transaction data may include additional data such as transaction timestamp, or whether the transaction is online or in a physical store, or whether the transaction is a card-present transaction that a purchase was made using a credit card, or other payment card.

In a variety of embodiments, the transaction data may include location data for the transaction. For example, the description server may extract a merchant identifier or merchant name from the transaction data and retrieve a merchant location (e.g. city or zip code) from the EMI database based on the merchant identifier or the merchant name. The transaction data may include context data for the transaction. For example, the transaction data may be obtained from a merchant device including a POS device at a merchant and the description server may determine that the context data may include a purchase from a physical store based on the POS device. The transaction data may be obtained from a merchant device handling online purchases and the description server may determine that the context data may include information that the transaction is associated with an online purchase.

In a variety of embodiment, the transaction data may also include an indication of one or more products associated with the transaction. For example, the transaction may be associated with an online transaction and a merchant shopping cart application may send the transaction data including the indication of one or more products to the description server. The raw transaction data may be in the form of a line of data that offers limited information about the transaction, with each piece of information appearing in certain locations within the line of data. The description server may perform a cleansing process to extract the merchant information from specific location of the line of data. For example, the description server may extract a merchant identifier, which may include 8-10 characters in the abbreviated form. The description server may process this abbreviated merchant identifier and convert it into a meaningful merchant name. The description server may query the EMI database to obtain the relevant merchant information. The description server may also extract the MCC from the line of data.

In a variety of embodiments, MCCs may be associated with an industry segment, such as catering, or personal services. MCCs may be associated with a specific type of goods or service that the merchants provide in the industry segment. For example, the travel industry segment may include steamship/cruise lines, airlines/air carriers, airports/fields/terminals, travel agencies, direct marketing-travel related, or timeshares etc.

At step 312, the description server may determine at least one feature of the transaction using a machine classifier. The features may be determined based on the entity code, the entity name, and the transaction value. The machine classifier may also determine a confidence metric indicating a likelihood that the feature is associated with the transaction. The machine classifier may be a supervised machine learning classifier and/or an unsupervised machine learning classifier. The machine classifier may use the entity code, the entity name and the transaction value, and the like as inputs to the machine classifier. The machine classifier may use additional input, such as location data, context data, or one or more products associated with the transaction. It should be readily apparent to one having ordinary skill in the art that a variety of machine classifier architectures can be utilized including (but not limited to) decision trees, k-nearest neighbors, support vector machines (SVM), neural networks (NN), recurrent neural networks (RNN), convolutional neural networks (CNN), probabilistic neural networks (PNN), transformer models, and the like. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine classifiers can be utilized, more specific machine classifiers when available, and general machine classifiers at other times can further increase the accuracy of predictions.

Merchant records in the EMI database and/or transaction records in the transaction database may be used as training data that is fed into the machine classifier. The training data may include a set of transaction data including entity codes (e.g. MCCs), entity names (e.g. merchant names), transaction values, and/or known features associated with the transactions. The training data may also include the entity locations (e.g. merchant locations) or context data associated with the transaction data. The machine classifier may also determine a score (e.g. a confidence score) to indicate the likelihood that the feature is associated with the transaction. The machine classifier may be tuned based on the confidence score exceeding a threshold value. The confidence score may be generated based on a similarity of a feature of the transaction to at least one of the features in the transaction data used to train the machine classifier. For example, the machine classifier may be tuned and the feature may be determined for the transaction when the confidence score, for example, reaches a 90% threshold. However, any threshold score can be used as appropriate. As such, the machine classifier may be trained on merchant location similarity, merchant name similarity, MCC similarity, transaction value similarity, context similarity and/or transaction similarity to probabilistically determine the appropriate features of the transaction.

In an example, the machine classifier may determine that the features of the transaction may include an online purchase of an airplane ticket with the departing time at 7 am and the arriving airport (e.g. New York City). In another example, if the transaction value is S20, the machine classifier may determine the transaction may be related to purchasing a drink in Ruth's Chris Steak House. If the transaction value is S200, the machine classifier may determine that the transaction may be related to a purchase of a steak and a bottle of wine in Ruth's Chris Steak House. The machine classifier may determine additional features such as whether the transaction may be considered as a high value purchase (e.g. S200) and a time of the day (e.g. the transaction occurred around 8 pm).

At step 314, the description server may determine a visual representation for each feature associated with the transaction. The description server may determine the visual representations using a deterministic logic (e.g. rule based logic) or a probabilistic (e.g. machine learning) determination. In a variety of embodiments, according to the deterministic approach, the description server may define one or more rules determining the mapping between the visual representations and the features of the transactions. The description server may use key words related to the features to search the Unicode emoji database and retrieve one or more emojis. For example, for the transaction at Ruth's Chris Steak House, the visual representation may include an emoji depicting a steak (e.g. prime rib emoji), an emoji depicting a wine glass, an emoji depicting a clock face showing 8 o'clock and an emoji depicting money-mouth-face, which is a smiley face with S signs in the eyes to represent that the transaction is a high-value transaction. For the transaction of airline ticket, the visual representation may include an emoji depicting an airplane, an emoji illustrating an airplane taking off and an emoji illustrating sunrise to represent departure time at 7 am, an emoji illustrating an airplane landing, and an emoji illustrating the Statue of Liberty to represent New York City as a destination.

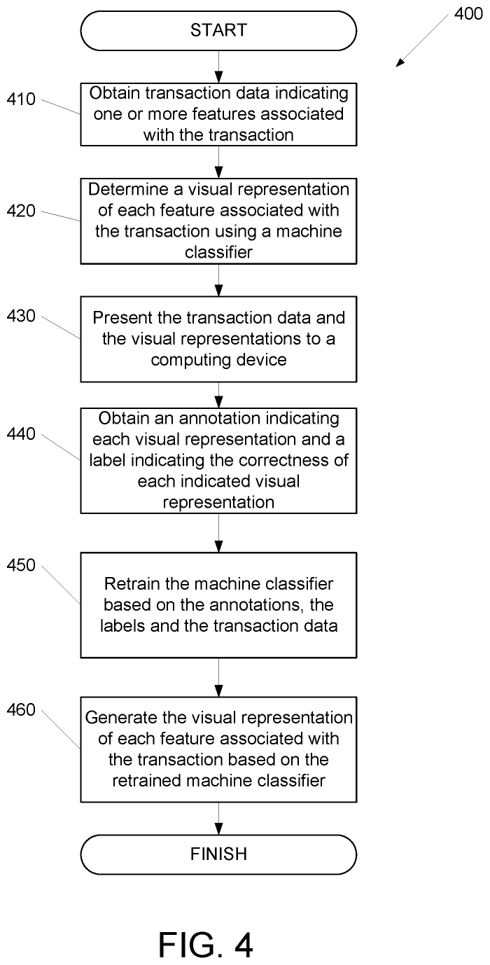

In a variety of embodiments, the selection of visual representations may not be implemented by keyword search or be readily defined by business rules. The description server may use the probabilistic approach to determine the mapping between the visual representations and the features of the transactions. For example, the description server may use a machine classifier to determine the visual representations associated with the transaction, as described in more detail with respect to FIG. 4.

The description server may store the transaction data with the features and visual representations in a database. For example, the transaction data may be stored in a transaction database. The merchant information including the entity name (e.g. merchant name), entity code (e.g. MCC), entity location (e.g. city or zip code) and the corresponding visual representations may also be store in the EMI database.

At step 316, the description server may generate a transaction summary including the transaction data and the visual representations of the features of the transaction. The transaction summary may display categories of previously conducted purchases made by a customer. The transaction data may be classified based on the entity code, such as the MCC. The transaction summary may include one or more reward programs that the customer may be eligible to participate or the promotional information on products or services related to the transaction. At step 318, the transaction summary may be provided to a computing device, such as a user device of a customer. The description server may send a notification to the user device with a message asking the customer to confirm the transaction. For example, the description server may send to the user device with a message “you have purchased an airline ticket to New York City, please confirm.” The description may send a notification to the user device with a message regarding promotional information on a product or service or a reward program that the customer may be eligible to participate, such as “you have booked a flight to New York City, are you interested in hotel information” or “you have earned 500 miles reward for this trip.”

FIG. 4 shows a flow chart of a process for determining the Unicode emojis using a machine classifier, according to one or more aspects of the disclosure. Some or all of the steps of process 400 may be performed using one or more computing devices as described herein. In a variety of embodiments, some or all of the steps described below may be combined and/or divided into sub-steps as appropriate.

At step 410, the description server may obtain transaction data indicating one or more features associated with the transaction. For example, the transaction data may indicate a transaction related to a purchase of a meal from Ruth's Chris Steak House. The transaction data may be obtained from a transaction stream or from a transaction database.

At step 420, the description server may determine a visual representation of each feature associated with the transaction using a machine classifier. The machine classifier may use training data such as a set of transaction records and the corresponding visual representations (e.g. emojis). The machine classifier may determine a visual representation of the feature and the corresponding confidence score. The machine classifier may be tuned based on the confidence score exceeding a threshold value (e.g. 90%). The machine classifier may determine visual representations for the features of the transaction. For example, the machine classifier may determine emojis depicting a steak and a wine glass for the transaction associated with Ruth's Chris Steak House.

At step 430, the description server may present the transaction data and the visual representations to a computing device, such as a user device. At step 440, the description server may obtain an annotation indicating each visual representation and a label indicating the correctness of each visual representation. For example, the customer may send, via the user device, an annotation for the steak and wine glass emojis, and a label (e.g. “Yes” for the steak emoji and “No” for the wine glass emoji) indicating the correctness of the emojis. The customer may further provide additional emoji that may more accurately depict the transaction, such as a whiskey glass emoji. The description server may receive the annotations and labels from a variety of user devices related to a plurality of transaction data, which may be used as a new training data set.

At step 450, the description server may retrain the machine classifier based on the annotations, the labels, and the transaction data in the new training data set. At step 460, the description server may generate the visual representation of each feature associated with the transaction based on the retrained machine classifier.

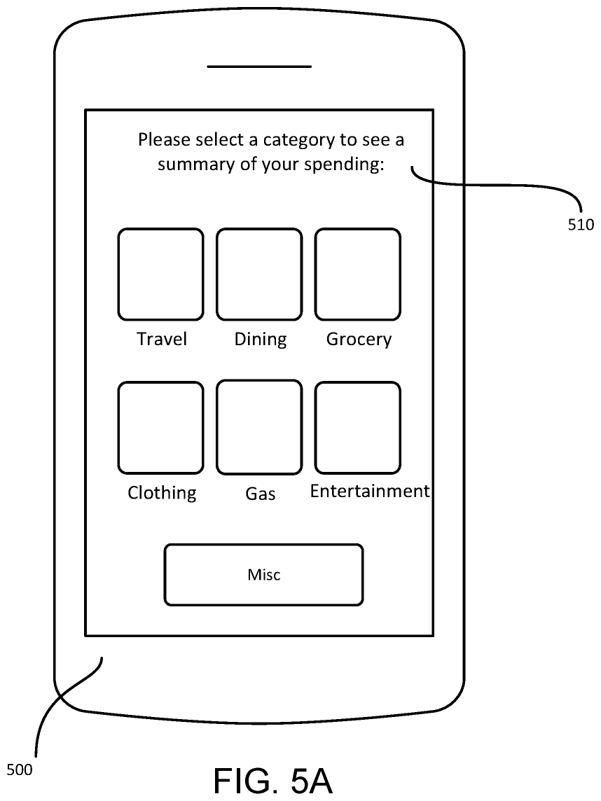

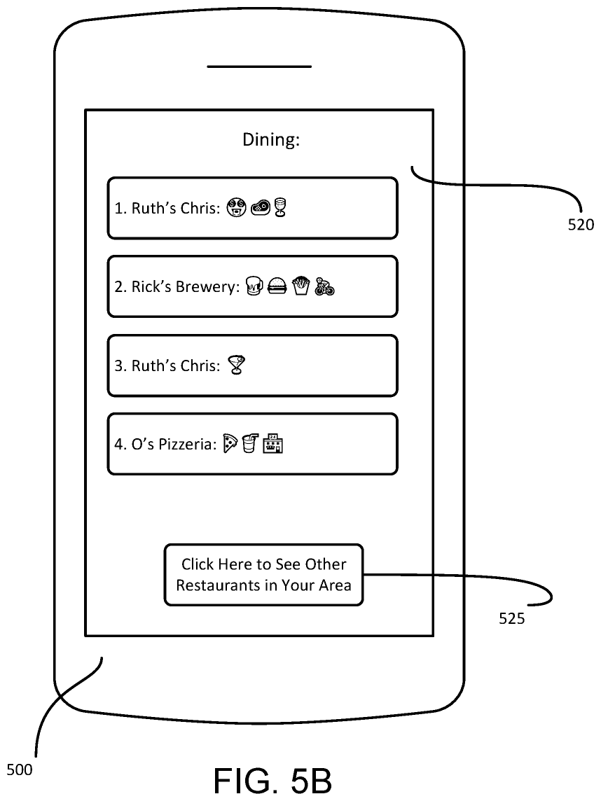

FIGS. 5A-5B show example user interfaces displaying visual representations (e.g. Unicode emojis) according to one or more aspects of the disclosure. FIG. 5A displays a transaction summary on a user device 500. A notification 510 may be sent to a user device 500 asking the customer to select a category from a transaction summary User device 500 may display a plurality of categories of spending that the customer has made in a certain period of time (e.g. a month or week). For example, the categories of spending may include expenditures related to travel services, dining services, grocery, clothing, gas, entertainment, and/or miscellanies etc. The customer may select a category of spending, such as dining to see the detailed expenditures and the transaction summary may display a list of restaurants or diners and the related expenditures in FIG. 5B.

With respect to FIG. 5B, display screen 520 of user device 500 may display, for example, four transactions related to the customer's dining expenditures with visual representations (e.g. Unicode emojis). The first expenditure is related to Ruth's Chris Steak House with three emojis: a money-face emoji depicting a high value expenditure, a steak emoji, and a wine glass emoji. The second expenditure is related to Rick's Brewery with four emojis: a beer emoji, a Hamburg emoji, a French fries emoji, and a bike emoji depicting the brewery is located near a bike trail. The third expenditure is related to Ruth's Chris Steak House with a cocktail emoji. The four expenditure is related to O's Pizzeria with three emojis: a pizza emoji, a soft drink emoji and a corner store emoji depicting that O's Pizzeria is a corner store. Display screen 520 may provide an option 525 to display other restaurants in the customer's vicinity that the customer may be interested to try based on his past dining expenditures. An option may include the rewards (not shown in FIG. 5B) that the customer may have earned or the rewards programs that the customer may be eligible to participate in the future. It should be noted that any categories or options can be displayed in accordance with various aspects of the disclosure.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
obtaining transaction data associated with an entity, the transaction data indicating an entity code, an entity name, and a transaction value;
determining, using a machine classifier and based on the entity code, the entity name, and the transaction value, at least one feature of the transaction, wherein each feature comprises a confidence metric indicating a likelihood that the feature is associated with the transaction;
determining, for each feature in the at least one feature, a visual representation of the feature;
generating a transaction summary comprising the transaction data and the determined visual representations of the features of the transaction; and
providing, to a computing device, the transaction summary.

2. The computer-implemented method of claim 1, wherein the visual representations comprise an emoji selected from Unicode Technical Standard #51.

3. The computer-implemented method of claim 1, wherein:
the transaction data further comprises location data for the transaction; and
at least one feature of the transaction is determined based on the location data.

4. The computer-implemented method of claim 1, wherein:
the transaction data further comprises context data for the transaction; and
at least one feature of the transaction is determined based on the context data.

5. The computer-implemented method of claim 1, further comprising:
obtaining, from the computing device, an annotation indicating a visual representation and a label indicating the correctness of the indicated visual representation; and
retraining the machine classifier based on the annotation, the label, and the transaction data.

6. The computer-implemented method of claim 1, wherein the transaction data is obtained from a point of sale device associated with the entity.

7. The computer-implemented method of claim 1, further comprising:
determining the value of the transaction exceeds a threshold value; and
associating multiple visual representations with the transaction data, wherein the multiple visual representations are associated with the value of the transaction.

8. The computer-implemented method of claim 1, further comprising:
determining a transaction category for the transaction based on the determined at least one feature; and
classifying, based on the transaction category, the transaction data in the transaction summary.

9. An apparatus, comprising:
one or more processors; and
memory storing instructions that, when executed by the one or more processors, cause the apparatus to:
obtain transaction data associated with an entity, the transaction data indicating an entity code, an entity name, and a transaction value;
determine, using a machine classifier and based on the entity code, the entity name, and the transaction value, at least one feature of the transaction, wherein each feature comprises a confidence metric indicating a likelihood that the feature is associated with the transaction;
determine, for each feature in the at least one feature, a visual representation of the feature;
generate a transaction summary comprising the transaction data and the determined visual representations of the features of the transaction;
provide, to a computing device, the transaction summary;
obtaining, from the computing device, an annotation indicating a visual representation and a label indicating the correctness of the indicated visual representation; and
retraining the machine classifier based on the annotation, the label, and the transaction data.

10. The apparatus of claim 9, wherein the visual representations comprise an emoji selected from Unicode Technical Standard #51.

11. The apparatus of claim 9, wherein:
the transaction data further comprises location data for the transaction; and
at least one feature of the transaction is determined based on the location data.

12. The apparatus of claim 9, wherein:
the transaction data further comprises context data for the transaction; and
at least one feature of the transaction is determined based on the context data.

13. The apparatus of claim 9, wherein the transaction data is obtained from a point of sale device associated with the entity.

14. The apparatus of claim 9, wherein the instructions, when executed by the one or more processors, cause the apparatus to:
determine the value of the transaction exceeds a threshold value; and
associate multiple visual representations with the transaction data, wherein the multiple visual representations are associated with the value of the transaction.

15. The apparatus of claim 9, wherein the instructions, when executed by the one or more processors, cause the apparatus to:
determine a transaction category for the transaction based on the determined at least one feature; and
classify, based on the transaction category, the transaction data in the transaction summary.

16. A non-transitory machine-readable medium storing instructions that, when executed by one or more processors, cause the one or more processors to perform steps comprising:
obtaining transaction data associated with an entity, the transaction data indicating an entity code, an entity name, a transaction value, location data indicating a location of the transaction, and context data for the transaction;
determining, using a machine classifier and based on the entity code, the entity name, the transaction value, the location data, and the context data, at least one feature of the transaction, wherein each feature comprises a confidence metric indicating a likelihood that the feature is associated with the transaction;
determining, for each feature in the at least one feature, a visual representation of the feature;
generating a transaction summary comprising the transaction data and the determined visual representations of the features of the transaction;
providing, to a computing device, the transaction summary;
obtaining, from the computing device, an annotation indicating a visual representation and a label indicating the correctness of the indicated visual representation; and
retraining the machine classifier based on the annotation, the label, and the transaction data.

17. The non-transitory machine-readable medium of claim 16, wherein the visual representations comprise an emoji selected from Unicode Technical Standard #51.

18. The non-transitory machine-readable medium of claim 16, wherein the transaction data is obtained from a point of sale device associated with the entity.

19. The non-transitory machine-readable medium of claim 16, wherein the instructions, when executed by the one or more processors, cause the one or more processors to perform steps comprising:
determining the value of the transaction exceeds a threshold value; and
associating multiple visual representations with the transaction data, wherein the multiple visual representations are associated with the value of the transaction.

20. The non-transitory machine-readable medium of claim 16, wherein the instructions, when executed by the one or more processors, cause the one or more processors to perform steps comprising:
determining a transaction category for the transaction based on the determined at least one feature; and
classifying, based on the transaction category, the transaction data in the transaction summary.
